(19) United States
(12) Patent Application Publication
(10) Pub. No.: US 2016/0233005 A1
(43) Pub. Date: Aug. 11, 2016

(54) ELECTRICAL DEVICE COMPRISING A CROSSLINKED LAYER

(71) Applicant: NEXANS, Paris (FR)

(72) Inventors: Bernard Dalbe, Lyon (FR); Jean-Francois Larche, Fleurieu-Sur-Saone (FR); Aurore Jabiole, Lyon (FR)

(21) Appl. No.: 15/018,061

(22) Filed: Feb. 8, 2016

(30) Foreign Application Priority Data
Feb. 10, 2015 (FR) 15 51051

(51) Int. Cl. H01B 7/02; H01B 3/44; H01B 3/46

(52) U.S. Cl. CPC H01B 7/0225; H01B 3/46; H01B 3/44; H01B 3/441

(57) ABSTRACT

An electrical device (1, 20, 30) includes a crosslinked layer (3, 4, 5) obtained from a crosslinkable polymer composition comprising a polymer material and a protective agent, characterized in that the protective agent is at least one siloxane oligomer.

### RELATED APPLICATION

This application claims the benefit of priority to French Patent Application No. 15 51051, filed on Feb. 10, 2015, the entirety of which is incorporated by reference.

### BACKGROUND

1. Field of the Invention

The present invention relates to an electrical device such as an electrical cable or electrical cable accessory, comprising at least one crosslinked layer.

The invention relates typically, but not exclusively, to the field of low-voltage (especially below 6 kV), medium-voltage (especially from 6 to 45-60 kV) or high-voltage (especially greater than 60 kV, which may be up to 800 kV) power cables, whether they are direct current or alternating current cables.

2. Description of Related Art

Medium-voltage and high-voltage power cables typically comprise a central electrical conductor surrounded by a succession of three crosslinked layers such as a first semiconductive layer, an electrically insulating layer and a second semiconductive layer.

This type of crosslinked layer generally comprises protective agents for controlling and reducing water absorption and. for ensuring the electrical insulation of the cable over time.

Conventionally, these protective agents may be lead-based compounds such as lead oxides. However, lead-based compounds are not environmentally friendly compounds.

### OBJECTS AND SUMMARY

The aim of the present invention is to overcome the drawbacks of the prior art by proposing an electrical device comprising an environmentally friendly crosslinked layer, while at the same time ensuring good electrical and mechanical properties throughout the life of the electrical device.

The subject of the present invention is an electrical device comprising a crosslinked layer obtained from a crosslinkable polymer composition comprising a polymer material and a protective agent, characterized in that the protective agent is a siloxane oligomer.

The invention advantageously presents an environmentally friendly electrical device, with a protection system not comprising any lead-based compound. More particularly, the crosslinked layer of the invention does not comprise any lead-based compound.

In addition, the crosslinked layer of the invention has very good mechanical and electrical properties, especially significantly limited water absorption and dielectric losses by virtue of this novel protective agent.

The crosslinked layer of the electrical device of the invention thus has electrical insulating properties that are stable over time.

More particularly, the crosslinked layer of the invention has dielectric losses, measured by the tangent delta(tan δ) value according to standard ASTM D150:
of not more than 0.020 at 130° C., after immersion in water at 90° C. for two weeks, and/or
of not more than 0.020 at 130° C., after immersion in water at 90° C. for four weeks.

### Siloxane Oligomer

The siloxane oligomer of the present invention is intended to control and reduce water absorption in the electrical device. It advantageously makes it possible to ensure good electrical insulation of the electrical device over time, by replacing the lead oxides used in the prior art for this type of function.

In the present invention, the term “siloxane oligomer” means a compound derived from the covalent sequence of a small number of identical or different siloxane monomer units, and more particularly derived from the covalent sequence of at least two identical or different siloxane monomer units. Preferably, the number of monomer units of the siloxane oligomer may range from 2 to 40, preferably from 2 to 20 and particularly preferably from 2 to 10.

The siloxane oiigomer conventionally comprises at least two “Si—O” groups, these groups especially constituting its main chain. In addition, the siloxane oligomer may comprise at least one alkoxy group.

Preferably, the siloxane oligomer is an alkyl oligomer or, in other words, an oligomer comprising at least one alkyl group. The alkyl oligomer may optionally comprise at least one alkene group.

According to a first variant, the alkyl siloxane oligomer may comprise at least one alkyl group and at least one alkene group. The alkene group may be of the vinyl type, for instance the CH₂═CH— group. It is then referred to as an alkyl vinyl siloxane oligomer.

According to a second variant, the alkyl siloxane oligomer may comprise only alkyl groups.

The siloxane oligomer may be linear, cyclic and/or branched.

In a first embodiment, the siloxane oligomer may be of the homooligomer type. In this respect, the siloxane homooligomer is a compound derived from the covalent sequence of a small number of identical monomer units.

Said monomer unit, or in other words each of the constituent monomer units of the homooligomer, may comprise at least one alkoxy group.

Said alkoxy group may be the group —OR₂ described below in formula I, or alternatively an alkoxy group whose alkyl group is other than R₂.

More particularly, the slioxane oligomer of the homooligomer type may be defined according to formula I below:

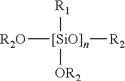

in which:
R₁ is chosen from the following groups: C₁-C₆ alkyl (linear or branched), halogen, vinyl, methacryloxyalkyl, acryloxyalkyl, glycidyloxyalkyl, bisalkoxysilylalkyl;
R₂ are identical or different groups and may be chosen, independently of each other, from the following groups: C₁-C₆ alkyl (linear or branched), preferably C₁-C₃ (linear or branched); and
n is an integer indicating the degree of oligomerization and may range from 2 to 40, preferably from 2 to 20, preferably from 2 to 10 and particularly preferably from 2 to 5.

Preferably, R₁ is chosen from the following groups: CH₃—, C₂H₅—, C₃H₇—, i—C₄H₉—, C₆H₁₃, i—C₆H₁₃—, CH₂═CH— (vinyl); and R₂ is chosen from the following groups : CH₃— or C₂H₅—.

Particularly preferably, R₁ is CH₃— and R₂ is C₂H—.

In a second embodiment, the siloxane oligomer may be of the cooligomer type. In this respect, the siloxane cooligomer is a compound derived from the covalent. sequence of a small number of different monomer units, preferably of at least two different monomer units.

Said two different monomer units may comprise:
a first monomer unit comprising at least a first alkoxy group, and
a second monomer unit comprising at least a second alkoxy group, the second alkoxy group being able especially to be identical to or different from the first alkoxy group.

Said first alkoxy group may be the group —OR′₁ described below in formula II, or an alkoxy group in which the alkyl group is other than R′₁.

Said second alkoxy group may be the group —OR′₁ described below in formula II, or an alkoxy group in which the alkyl group is other than R′₁.

More particularly, the siloxane oligomer of the cooligomer type may be defined according to formula II below:

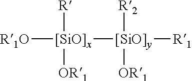

in which:
R′₁ are identical or different groups and may be chosen, independently of each other, from the following groups: C₁-C₆ alkyl (linear or branched), preferably C₁-C₃ (linear or branched);
R′ and R′₂ are identical or different groups and may be chosen, independently of each other, from the following groups: C₁-C₆ alkyl (linear or branched), halogen, vinyl, methacryloxyalkyl, acryloxyalkyl, glycidyloxyalkyl, bisalkoxysilylalkyl; and
x and y are identical or different integers, the sum of which indicates the degree of oligomerization. The sum “x+y” may range from 2 to 40, preferably from 2 to 20, preferably from 2 to 10 and particularly preferably from 2 to 5.

Preferably, R′₂ and R′ are independently chosen from the following groups: CH₃—, C₂H₅—, C₃H₇—, i—C₄H₉—, C₆H₁₃^{—}, i—C₆H₁₃, CH₂═CH— (vinyl); and R′₁ is chosen from the following groups: CH₃— or C₂H₅—.

Particularly preferably, R′₁ is C₂H₅—, R′ is CH₂═CH—, and R′₂ is C₃H₇—.

The cooligomer of the second embodiment may preferably be an alkyl vinyl siloxane oligomer.

The crosslinkable composition of the invention may comprise a sufficient amount of siloxane oligomer to be able to obtain the desired properties.

By way of example, the crosslinkable polymer composition may comprise not more than 10.0 parts by weight of siloxane oligomer, and preferably not more than 5.0 parts by weight of siloxane oligomer, per 100 parts by weight of polymer material in the crosslinkable composition. The crosslinkable polymer composition may also comprise at least 0.1 part by weight of siloxane oligomer per 100 parts by weight of polymer material in the crosslinkable composition.

In the present invention, the siloxane homooligomer is especially the protective agent that is particularly preferred for optimizing the desired properties.

The crosslinkable polymer composition of the invention may also comprise at least one siloxane monomer.

The siloxane monomer conventionally comprises only one “Si—O” group. In addition, the siloxane monomer may comprise at least one alkoxy group.

By way of example, a siloxane monomer may be:
a compound represented by formula I with n=1, or
a compound represented by formula II with x=1 and y=0, or x=0 and y=1.

The crosslinkable polymer composition may comprise not more than 10.0 parts by weight of siloxane monomer, and preferably not more than 5.0 parts by weight of siloxane monomer, per 100 parts by weight of polymer material in the crosslinkable polymer composition. The crosslinkable polymer composition may also comprise at least 0.1 part. by weight of siloxane monomer per 100 parts by weight of polymer material in the crosslinkabie polymer composition.

### The Polymer Material

The polymer material of the invention may comprise one or more polymers, the term “polymer” being able to be understood as any type of polymer that is well known to those skilled in the art such as homopolymer or copolymer (e.g. block copolymer, random copolymer, terpolymer, etc.).

The polymer material is especially different from the siloxane oligomer. The polymer material is conventionally derived from the covalent sequence of a large number of identical or different monomer units, and more particularly derived from the covalent sequence of more than 40 identical or different monomer units.

The polymer may be of the thermoplastic or elastomer type, and may be crosslinked via techniques that are well known to those skilled in the art.

In a particular embodiment, the polymer material, or in other words the polymer matrix of the crosslinkable composition, may comprise one or more olefin polymers, and preferably one or more ethylene polymers and/or one or more propylene polymers. An olefin polymer is conventionally a polymer obtained from at least one olefin monomer.

More particularly, the polymer material comprises more than 50% by weight of olefin polymer (s), preferably more than 70% by weight of olefin polymer (s), and particularly preferably more than 90% by weight of olefin polymer(s), relative to the total weight of polymer material. Preferably, the polymer material is composed solely of one or more olefin polymer(s), and preferably of one or more ethylene polymer(s).

By way of example, the polymer material of the invention may comprise one or more olefin polymers chosen from a linear low density polyethylene (LLDPE); a very low density polyethylene (VLDPE); a low density polyethylene (LDPE); a medium density polyethylene (MDPE); a high density polyethylene (HDPE); an ethylene-propylene elastomer copolymer (EPR); an ethylene propylene diene monomer (EPDM) terpolymer; a copolymer of ethylene and of vinyl ester such as a copolymer of ethylene and of vinyl acetate (EVA); a copolymer of ethylene and of acrylate such as a copolymer of ethylene and of butyl acrylate (EB) or a copolymer of ethylene and of methyl acrylate (EMA); a copolymer of ethylene and of α-olefin such as a copolymer of ethylene, and of octene (PEO) or a copolymer of ethylene and of butene (PEP); a functionalized olefin polymer; polypropylene; a propylene copolymer; and a mixture thereof.

Preferably, the polymer material is chosen from an ethylene-propylene-(diene)-monomer (EPDM) terpolymer, an ethylene-propylene rubber (EPR), and a mixture thereof.

The crosslinkable polymer composition of the invention may comprise at least 20% by weight of polymer material, preferably at least 30% by weight of polymer material and preferably at least 40% by weight of polymer material, relative to the total weight of the crosslinkable polymer composition.

### The Crosslinkable Polymer Composition

The polymer composition of the invention is a crosslinkable composition.

It may be advantageously free of halogenated compounds.

The crosslinkable polymer composition is crosslinked via crosslinking processes that are well known to those skilled in the art, for instance peroxide crosslinking, electron beam crosslinking, silane crosslinking, ultraviolet radiation crosslinking, etc.

The preferred process for crosslinking the polymer composition is peroxide crosslinking. In this respect, the crosslinkable polymer composition may comprise a crosslinking agent of the organic peroxide type.

The polymer composition may comprise a sufficient amount of one or more crosslinking agents, so as to obtain said crosslinked layer.

By way of example, the crosslinkable polymer composition may comprise from 0.01 to 10.0 parts by weight of crosslinking agent per 100 parts by weight of polymer material in the crosslinkable polymer composition.

Preferably, especially during the use of a crosslinking agent of organic peroxide type, the crosslinkable polymer composition may advantageously comprise not more than 5.0 parts by weight of crosslinking agent, and preferably not more than 2.0 parts by weight of crosslinking agent, per 100 parts by weight of polymer material in the crosslinkable polymer composition.

The polymer composition of the invention may also comprise a metal oxide, for instance zinc oxide (ZnO). Depending on the type of polymer material used, the metal oxide may act as heat stabilizer and/or improve the electrical properties of the crosslinked layer.

The metal oxide may be added to the crosslinkable polymer composition in an amount that may range from 1.0 to 10.0 parts by weight per 100 parts by weight of polymer material.

### The Fillers

The crosslinkable polymer composition of the invention may also comprise one or more fillers.

The filler of the invention may he a mineral or organic filler. It may be chosen from an inert or reinforcing filler.

The inert or reinforcing filler may be chosen from at least one of the following fillers: clay (kaolin), preferably calcined; chalk; talc.

In a particular embodiment, the crosslinkable polymer composition of the invention does not comprise any hydrated filler or filler liable to release water. As examples of hydrated fillers or fillers liable to release water, mention may be made of metal hydroxides, for instance magnesium dihydroxide (MDH) or aluminum trihydroxide (ATH). This type of filler has the drawback of having a negative impact on the desired properties in the present invention.

The crosslinkable polymer composition may comprise at least 1% by weight of filler(s), preferably at least 10% by weight of filler (s) and preferably not more than 50% by weight of filler(s), relative to the total weight of the crosslinkable polymer composition.

According to another characteristic of the invention, and in order to ensure a “halogen-free” electrical device, the electrical device, or in other words the elements which compose said electrical device, preferably do not comprise any halogenated compounds. These halogenated compounds may be of any nature, for instance fluorinated polymers or chlorinated polymers such as polyvinyl chloride (PVC), halogenated plasticizers, halogenated mineral fillers, etc.

### The Additives

The crosslinkable polymer composition of the invention may also typically comprise additives in an amount of from 0.01% to 20% by weight relative to the total weight of the crosslinkable polymer composition.

The additives are well known to those skilled in the art and may be chosen, for example, from:
protective agents, such as antioxidants, UV stabilizers, anti-copper agents, water-tree-resistance agents,
processing agents, such as plasticizers, lubricants (e.g. zinc stearate), oils, waxes,
compatibilizers,
coupling agents,
scorch retardants,
pigments,
crosslinking catalysts,
crosslinking coagents such as triallyl cyanurates,
and a mixture thereof.

More particularly, the antioxidants make it possible to protect the composition against the thermal stresses generated during the steps of manufacture of the device or of functioning of the device.

The antioxidants are preferably chosen from:
sterically hindered phenolic antioxidants, such as tetrakismethylene(3,5-di-t-butyl-4-hydroxy-hydrocinnamate)methane, octadecyl 3-(3,5-di-t-butyl-4-hydroxyphenyl)propionate, 2,2′-thiodiethylenebis[3-(3,5-di-t-butyl-4-hydroxyphenyl)propionate], 2,2′-thiobis(6-t-butyl-4-methylephenol), 2,2′-methylenebis(6-t-butyl-4-methylphenol), 1,2-bis(3,5-di-t-butyl-4-hydroxyhydro-cinnamoyl)hydrazine, and [2,2′-oxamidobis(ethyl 3(3,5-di-t-butyl-4-hydroxyphenyl) propionate)];
thioethers such as 4,6-bis(octylthiomethyl)-o-cresol, bis[2-methyl-4-{3-n-alkyl (C12 or C14)thiopropionyloxy}-5-t-butylphenyl] sulfide and thiobis[2-t-butyl-5-methyl-4,1-phenylene]bis[3-(dodecylthio)propionate];
sulfur-based antioxidants such as dioctadecyl 3,3′-thiodipropionate or didodecyl 3,3′-thiodipropionate;
phosphorus-based antioxidants such as phosphites or phosphonates, for instance tris(2,4-di-t-butyl-phenyl) phosphite or bis(2,4-di-t-butylphenyi) butylphenyl diphosphite; and
antioxidants of amine type such as phenylenediamines (IPPD, 6PPD, etc.), diphenylaminestyrene, diphenylamines, mercaptobenzimidazoles and polymerized 2,2,4-trimethyl-1,2-dihydroquinoline (TMQ).

The TMQs may have various grades, namely:
a “standard” grade with a low degree of polymerization, i.e. with a residual monomer content of greater than 1% by weight and having a residual NaCl content which may range from 100 ppm to more than 800 ppm (parts per million by mass);
a “high degree of polymerization” grade with a high degree of polymerization, i.e. with a residual monomer content of less than 1% by weight and having a residual NaCl content which may range from 100 ppm to more than 800 ppm;
a “low residual salt content” grade with a residual NaCl content of less than 100 ppm.

The type of stabilizer and its content in the composition of the invention are conventionally chosen as a function of the maximum temperature to which the polymers are subjected during the production of the mixture and during their use, especially by extrusion, and also depending on the maximum exposure time at this temperature.

The Crosslinked Layer and the Electrical Device

In the present invention, the crosslinked layer may be readily characterized by determination of its gel content according to standard ASTM D2765-01.

More particularly, said crosslinked layer may advantageously have a gel content, according to standard ASTM D2765-01 (extraction with xylene), of at least 50%, preferably at least 70%, preferably at least 80%, and particularly preferably at least 90%.

The crosslinked layer of the invention may be chosen from an electrically insulating layer, a protective sheath, and a combination thereof. The crosslinked layer of the invention may be the outermost layer of the electrical device.

In the present invention, the term “electrically insulating layer” means a layer whose electrical conductivity may be not more than 1×10⁻⁹ S/m (Siemens per meter) (at 25° C.) and preferably not more than 1×10⁻¹² S/m (at 25° C.).

The crosslinked layer of the invention may be an extruded layer or a molded layer, produced via processes, that are well known to those skilled in the art.

The electrical device of the invention more particularly concerns the field of electric cables or electric cable accessories, supplying direct current (DC) or alternating current (AC).

The electrical device of the invention may he an electric cable or an electric cable accessory.

According to a first embodiment, the device according to the invention is an electric cable comprising an elongated electrically conductive element, surrounded with said crosslinked layer. Preferably, the crosslinked layer is an electrically insulating layer.

In this embodiment, the crosslinked layer is preferably a layer extruded via techniques that are well known to those skilled in the art.

The crosslinked layer of the invention may surround the elongated electrically conductive element according to several variants.

According to a first variant, the crosslinked layer may be directly in physical contact with the elongated electrically conductive element. This first variant is referred to as a low-voltage cable.

According to a second variant, the crosslinked layer may be the electrically insulating layer of an insulating system comprising:
a first semiconductive layer surrounding the electrically conductive element,
an electrically insulating layer surrounding the first semiconductive layer, and
a second semiconductive layer surrounding the electrically insulating layer.

More particularly, the elongated electrically conductive element may be surrounded with a first semiconductive layer, an electrically insulating layer surrounding the first semiconductive layer, and a second semiconductive layer surrounding the electrically insulating layer, the crosslinked layer being the electrically insulating layer.

This second variant is referred to as a medium-voltage or high-voltage cable.

According to a second embodiment, the device according to the invention is an electric cable accessory, said accessory comprising said crosslinked layer.

Said accessory is intended to surround, or surrounds when it is positioned around the cable, the elongated electrically conductive element of an electric cable.

More particularly, said accessory is intended to surround or surrounds an electric cable, and is preferably intended to surround or surrounds at least one part. or end of an electric cable. The accessory may especially be a junction or a termination for an electric cable.

The accessory may typically be a longitudinal hollow body, for instance a junction or a termination for an electric cable, in which at least part of an electric cable is intended to be positioned.

The accessory comprises at least one semiconductive element and at least one electrically insulating element, these elements being intended to surround at least one part or end of an electric cable. The semiconductive element is well known for controlling the geometry of the electric field, when the electric cable, combined with said accessory, is live.

The crosslinked layer of the invention may be said electrically insulating element of the accessory.

When the accessory is a junction, it makes it possible to connect two electric cables together, the junction being intended to surround or surrounding these two electric cables at least partly. More particularly, the end of each electric cable intended to be connected is positioned inside said junction.

When the device of the invention is a termination for an electric cable, the termination is intended to surround or surrounds an electric cable at least partly. More particularly, the end of the electric cable intended to be connected is positioned inside said termination.

When the electrical device is an electric cable accessory, the crosslinked layer is preferably a layer molded via techniques that are well known to those skilled in the art.

In the present invention, the elongated electrically conductive element of the electric cable may be a metal wire or a plurality of metal wires, which may or may not be braided, especially made of copper and/or aluminum, or an alloy thereof.

Another subject of the invention concerns a process for manufacturing an electric cable according to the invention, characterized in that it comprises the following steps:
i. extruding the crosslinkable polymer composition around an elongated electrically conductive element, to obtain an extruded layer, and
ii. crosslinking the extruded layer from step i.

Step i may be performed via techniques that are well known to those skilled in the art, using an extruder.

During step i, the composition exiting the extruder is said to be “non-crosslinked”, the operating time and temperature in the extruder being optimized in consequence.

The term “non-crosslinked” refers to a layer whose gel content according to standard ASTM D2765-01 (extraction with xylene) is not more than 20%, preferably not more than 10%, preferably not more than 5% and particularly preferably 0%.

On exiting the extruder, an extruded layer is thus obtained around said electrically conductive element, which may or may not be in direct physical contact with said electrically conductive element.

Prior to step i, the constituent compounds of the polymer composition of the invention may be mixed, especially with the polymer material in molten form, so as to obtain a homogeneous mixture. The temperature in the mixer may be sufficient to obtain a polymer material in molten form, but is limited to avoid decomposition of the crosslinking agent when it exists, and thus crosslinking of the polymer material.

Next, the homogeneous mixture may be granulated, via techniques that are well known to those skilled in the art. These granules may then be fed into an extruder to perform step i. Alternatively, the mixture may be prepared in the form of strips, especially when the polymer material is of the elastomer type, the strips being used to feed an extruder to perform step i.

Step ii may be performed thermally, for example using a continuous vulcanization line (“CV line”), a vapor tube, a molten salt bath, an oven or a heating chamber, these techniques being well known to those skilled in the art.

Step ii thus makes it possible to obtain a crosslinked layer, especially having a gel content, according to standard ASTM D2765-01, of at least 40%, preferably of at least 50%, preferably of at least 60% and particularly preferably of at least 70%.

Another subject of the invention concerns a process for manufacturing an electric cable accessory, characterized in that it comprises the following steps:
i. molding the crosslinkable polymer composition, to obtain a molded layer, and
ii. crosslinking the molded layer from step i.

Step i may be performed via techniques that are well known to those skilled in the art, especially by molding or injection-molding.

Prior to step i, the constituent compounds of the polymer composition of the invention may be mixed, as described above for the manufacture of a cable.

Step ii may be performed thermally, for example using a heating mold, which may be the mold used in step i. In the mold, the composition from step i may then be subjected to a sufficient temperature and for a sufficient time to be able to obtain the desired crosslinking. A molded and crosslinked layer is then obtained.

Step ii thus makes it possible to obtain a crosslinked layer, especially having a gel content, according to standard ASTM D2765-01, of at least 40%, preferably of at least 50%, preferably of at least 60% and particularly preferably of at least 70%.

The crosslinked layer may also be characterized by standard NF EN 60811-2-1 (or “hot set test”) with a hot creep under load (percentage elongation under load) of not more than 175%.

In the present invention, the crosslinking temperature and the crosslinking time used for the extruded and/or molded layer depend especially on the thickness of the layer, on the number of layers, on the presence or absence of a crosslinking catalyst, on the type of crosslinking, etc.

A person skilled in the art can readily determine these parameters according to the evolution. of the crosslinking by means of determining the gel content according to standard ASTM D2765-01 to obtain a crosslinked layer.

When an extruder is used, the temperature profile of the extruder and the extrusion rate are parameters that a person skilled in the art can also vary to ensure that the desired properties are obtained.

### BRIEF DESCRIPTION OF THE DRAWINGS

Other characteristics and advantages of the present invention will emerge on reading the description of nonlimiting examples of an electric cable according to the invention and of an electric cable accessory according to the invention, which are given with reference to the figures.

FIG. 1 is a schematic view of an electric cable according to a preferred embodiment in accordance with the invention.

FIG. 2 is a schematic view of an electrical device according to the invention, comprising a junction in longitudinal cross section, this junction surrounding the end of two electric cables.

FIG. 3 is a schematic view of an electrical device according to a first variant of the invention, comprising a termination in longitudinal cross section, this termination surrounding the end of a single electric cable.

### DETAILED DESCRIPTION

For the sake of clarity, only the elements that are essential for understanding the invention have been represented schematically, and are not to scale.

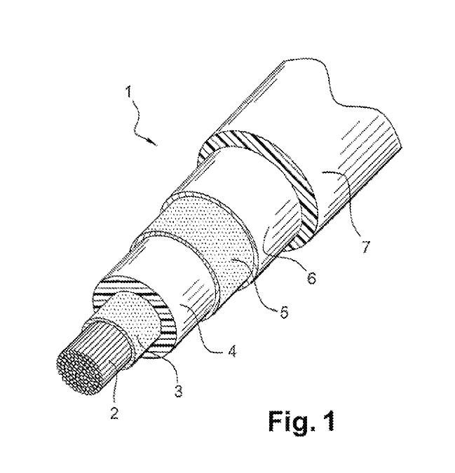

The medium-voltage or high-voltage power cable 1, illustrated in FIG. 1, comprises an elongated central conductive element 2, especially made of copper or aluminum. The power cable 1 also comprises several layers arranged successively and coaxially around this conductive element 2, namely: a first semiconductive layer 3 known as the “inner semiconductive layer”, an electrically insulating layer 4, a second semiconductive layer 5 known as the “outer semiconductive layer”, an earthing and/or protective metal screen 6, and a protective outer sheath 7.

The electrically insulating layer 4 is an extruded and crosslinked layer, which may be obtained from the crosslinkable polymer composition according to the invention.

The semiconductive layers are also extruded and crosslinked layers.

The presence of the metal screen 6 and of the protective outer sheath 7 is preferential, but not essential, this cable structure being, per se, well known to those skilled in the art.

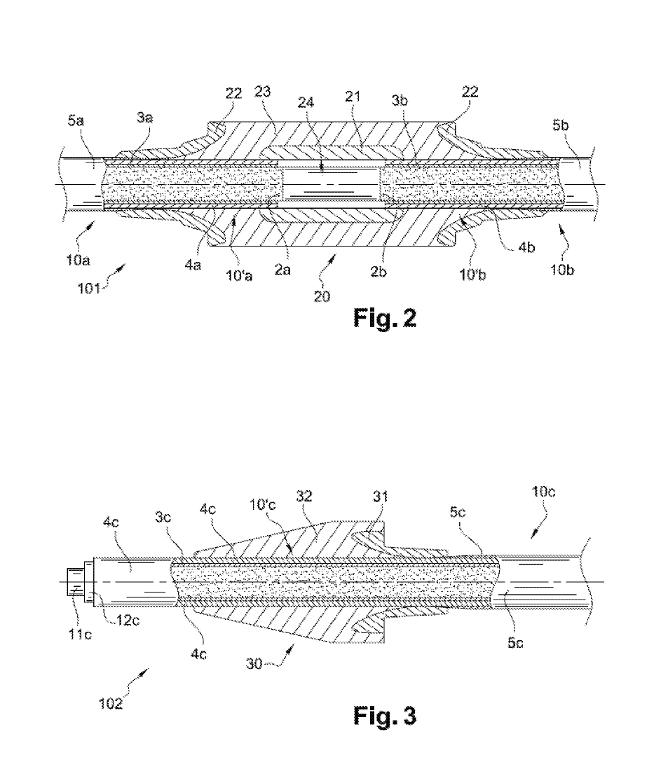

FIG. 2 represents a device 101 comprising a junction 20 partly surrounding two electric cables 10a and 10b.

More particularly, the electric cables 10a and 10b comprise, respectively, an end 10′a and 10′b intended to be surrounded with the junction 20.

The body of the junction 20 comprises a first semiconductive element 21 and a second semiconductive element 22, separated by an electrically insulating element 23, said semiconductive elements 21, 22 and said electrically insulating element 23 surrounding the ends 10′a and 10′b, respectively, of the electric cables 10a and 10b.

This junction 20 allows the first cable 10a to be electrically connected to the second cable 10b, especially by means of an electrical connector 24 arranged at the center of the junction 20.

Said electrically insulating element 23 may be a crosslinked layer as described in the invention.

The first electric cable 10a comprises an electrical conductor 2a surrounded with a first semiconductive layer 3a, an electrically insulating layer 4a surrounding the first semiconductive layer 3a, and a second semiconductive layer 5a surrounding the electrically insulating layer 4a.

The second electric cable 10b comprises an electrical conductor 2b surrounded with at least a first semiconductive layer 3b, an electrically insulating layer 4b surrounding the first semiconductive layer 3b, and a second semiconductive layer 5b surrounding the electrically insulating layer 4b.

These electric cables 10a and 10b may be those described in the present invention.

At said end 10′a, 10′b of each electric cable 10a, 10b, the second semiconductive layer 5a, 5b is at least partially stripped so that the electrically insulating layer 4a, 4b is at least partially positioned inside the junction 20, without being covered with the second semiconductive layer 5a, 5b of the cable.

Inside the junction 20, the electrically insulating layers 4a, 4b are in direct physical contact with the electrically insulating element 23 and the first semiconductive element 21 of the junction 20. The second semiconductive layers 5a, 5b are in direct physical contact with the second semiconductive element 22 of the junction 20.

FIG. 3 represents a device 102 comprising a termination 30 surrounding a single electric cable 10c.

More particularly, the electric cable 10c comprises an end 10′c, intended to be surrounded with the termination 30.

The body of the termination 30 comprises a semiconductive element 31 and an electrically insulating element 32, said semiconductive element. 31 and said electrically insulating element 32 surrounding the end 10′c of the electric cable 10c.

Said electrically insulating element 32 may be a crosslinked layer as described in the invention.

The electric cable 10c comprises an electrical conductor 2c surrounded with a first semiconductive layer 3c, an electrically insulating layer 4c surrounding the first semiconductive layer 3c, and a second semiconductive layer 5c surrounding the electrically insulating layer 4c.

This electric cable 10c may be that described in the present invention.

At said end 10′c of the electric cable 10c, the second semiconductive layer 5c is at least partially stripped so that the electrically insulating layer 4c is at least partially positioned inside the termination 30, without being covered with the second semiconductive layer 5c of the cable.

Inside the termination 30, the electrically insulating layer 4c is in direct physical contact with the electrically insulating element 32 of the termination 30. The second semiconductive layer 5c is in direct physical contact with the semiconductive element 31 of the junction 30.

### EXAMPLES

1. Electrically Insulating Crosslinkable Polymer Compositions

Table 1 below collates crosslinkable polymer compositions, the amounts of the compounds of which are expressed in parts by weight per 100 parts by weight of polymer material in the crosslinkable polymer composition.

The polymer material in Table 1 is composed solely of EPDM.

Compositions C1 to C4 are comparative tests, and compositions I1 to I2 are in accordance with the invention.

TABLE 1

| | Crosslinkable polymer compositions | | | | | |
|---|---|---|---|---|---|---|
| | C1 | C2 | C3 | C4 | I1 | I2 |
| Polymer | 100 | 100 | 100 | 100 | 100 | 100 |
| material | | | | | | |
| Filler | 65 | 65 | 65 | 65 | 65 | 65 |
| Heat stabilizer | 5 | 5 | 5 | 5 | 5 | 5 |
| Lead oxide | 4 | 0 | 0 | 0 | 0 | 0 |
| VTEO | 0 | 2 | 0 | 0 | 0 | 0 |
| MEMO | 0 | 0 | 2 | 0 | 0 | 0 |
| VTMOEO | 0 | 0 | 0 | 4 | 0 | 0 |
| Siloxane | 0 | 0 | 0 | 0 | 2 | 0 |
| oligomer 1 | | | | | | |
| Siloxane | 0 | 0 | 0 | 0 | 0 | 2 |
| oligomer 2 | | | | | | |
| Processing | 24 | 24 | 24 | 24 | 24 | 24 |
| agents | | | | | | |
| Crosslinking | 0.17 | 0.17 | 0.17 | 0.17 | 0.17 | 0.17 |
| coagent | | | | | | |
| Antioxidant | 1 | 1 | 1 | 1 | 1 | 1 |
| Crosslinking | 1.67 | 1.67 | 1.67 | 1.67 | 1.67 | 1.67 |
| agent | | | | | | |

The origin of the compounds of Table 1 is as follows:
polymer material is EPDM sold by the company Dow under the reference Nordel IP4520;
inert filler is calcined kaolin sold by the company IMERYS under the reference Polarite 503S;
heat stabilizer is zinc oxide (ZnO), sold by the company Grillo-Werke AG under the reference ZnO pharma 4;
lead oxide sold by the company OMYA under the reference Multidisperse ERD90;
VTEO is a silane monomer of the vinyltriethoxysilane type, sold by the company Evonik under the reference Dynasylan VTEO;
MEMO is a silane monomer of the methacryloxypropyltrimethoxysilane type, sold by the company Evonik under the reference Dynasylan MEMO;
VTMOEO is a silane monomer of the vinyltrimethoxyethoxysilane type, sold by the company Evonik under the reference Dynasylan VTMOEO;
siloxane oligomer 1 comprises a methyltriethoxysilane homooligomer, and is sold by the company Crompton under the reference Silquest RC-1 Silane;
siloxane oligomer 2 comprises a siloxane cooligomer with vinyl, propyl and ethoxy groups, and is sold by the company Evonik under the reference Dynasylan 6598;
processing agents comprises:
   3 parts by weight of polyethylene wax per 100 parts by weight of polymer material in the crosslinkable polymer composition, said wax being sold by the company Honeywell under the reference Polyethylene A-C;
   1 part by weight of zinc stearate (lubricant) per 100 parts by weight of polymer material in the crosslinkable polymer composition, said zinc stearate being sold by the company Peter Greven under the reference LIGA; and
   20 parts by weight of liquid paraffin per 100 parts by weight of polymer material in the crosslinkable polymer composition, said liquid paraffin being sold by the company Nynas under the reference Nypar;
   crosslinking coagent is a triallyl cyanurate, said by the company Kettlitz under the reference TAC/70;
   antioxidant is a polymerized 2,2,4-trimethyl-1,2-dihydroguinoline, sold by the company Flexsys under the reference Flectol TMQ; and
   crosslinking agent is an organic peroxide such as dicumyl peroxide (DCP), sold by the company Arkema under the reference Luperox DCP, the half-life of which is 6 minutes at 162° C.

2. Preparation of the Crosslinked Layers

The compositions collated in Table 1 are used as follows.

In a first stage, for each composition (C1 to C4, I1 and I2), the various constituents are mixed with the polymer material (EPDM) at a temperature of about 115 to 120° C., in an internal mixer.

In a second stage, once the compositions have been mixed, 100×100 mm plaques with a thickness of 1 mm are formed, using a two-roll mill inside which the mixed compositions pass.

Finally, said plagues are crosslinked in a compression-molding press, at a temperature of 180° C.

3. Characterization of the Crosslinked Layers

The dielectric losses, evaluated by measuring the tangent (Tan δ), were measured using the plaques formed above, according to standard ASTM D150 (Protocol for measuring the tangent delta).

The measurements are taken using a Diana dielectric analyzer on samples 10 cm in diameter and 1 mm thick, taken from the crosslinked plaques.

The sample is introduced into the Diana dielectric analyzer and the measurements are taken at a voltage of 1 kV. On the same sample, the tangent delta measurement is performed successively at 3 temperatures: 23° C., 90° C. and 130° C. The results given in the table for each temperature are the mean of 3 measurements taken on 3 different samples. This method is applied successively in the following manner:
on the non-aged samples;
on these same samples after immersion at 90° C. in distilled water for 2 weeks; and
on these same samples after immersion at 90° C. in distilled water for 4 weeks.

The tangent delta (Tan δ) results regarding the crosslinked plaques (samples) obtained from compositions C1 to C4, I1 and I2 in Table 1 are collated in Table 2 below.

TABLE 2

| | Measurement | | | | | | |
|---|---|---|---|---|---|---|---|
| Samples | temperatures | C1 | C2 | C3 | C4 | I1 | I2 |
| Tan δ befor immersion | to 90° C. | 0.0016 | 0.0017 | 0.0018 | 0.0064 | 0.0020 | 0.0019 |
| | to 130° C. | 0.0041 | 0.0053 | 0.0059 | 0.0091 | 0.0052 | 0.006 |
| Tan δ after immersion | to 90° C. | 0.019 | 0.0092 | 0.0112 | 0.065 | 0.0031 | 0.0052 |
| in water at 90° C. for | to 130° C. | 0.059 | 0.025 | 0.028 | 0.118 | 0.009 | 0.015 |
| 2 weeks | | | | | | | |
| Tan δ after immersion | to 90° C. | 0.020 | 0.0082 | 0.012 | 0.028 | 0.0039 | 0.0076 |
| in water at 90° C. for | to 130° C. | 0.055 | 0.024 | 0.031 | 0.12 | 0.012 | 0.015 |
| 4 weeks | | | | | | | |

Consequently, the crosslinked layer of the invention (compositions I1 and I2) has very good dielectric properties, especially tangent delta values whose increase is significantly limited, which is not more than 0.020 at 130° C., after immersion in water at 90° C. for two weeks, and not more than 0.020 at 130° C., after immersion in water at 90° C. for four weeks.

More particularly, these properties are even further improved by using a siloxane homooligomer (composition I1) relative to a siloxane cooligomer (composition I2).

1. Electrical device comprising:
a crosslinked layer obtained from a crosslinkable polymer composition having a polymer material and a protective agent,
wherein the protective agent is at least one siloxane oligomer.

2. Device according to claim 1, wherein the siloxane oligomer comprises from 2 to 40 monomer units.

3. Device according to claim 1, wherein the siloxane oligomer is a siloxane homooligomer.

4. Device according to claim 1, wherein the siloxane oligomer is a siloxane cooligomer.

5. Device according to claim 4, wherein the siloxane cooligomer has at least two different monomer units, said two monomer units comprising:
a first monomer unit having at least a first alkoxy group, and
a second monomer unit having at least a second alkoxy group.

6. Device according to claim 1, wherein the siloxane oligomer is an alkyl oligomer or an alkyl vinyl oligomer.

7. Device according to claim 1, wherein the crosslinkable polymer composition has a crosslinking agent.

8. Device according to claim 7, wherein the crosslinking agent is an organic peroxide.

9. Device according to claim 1, wherein the polymer material has one or more olefin polymers.

10. Device according to claim 9, wherein the polymer material is chosen from an ethylene-propylene-(diene)-monomer (EPDM) terpolymer, an ethylene-propylene rubber (EPR), and a mixture thereof.

11. Device according to claim 1, wherein the crosslinkable polymer composition also comprises at least one siloxane monomer.

12. Device according to claim 1, wherein said device is an electric cable having an elongated electrically conductive element, surrounded with said crosslinked layer.

13. Device according to claim 12, wherein the elongated conductive element is surrounded with a first semiconductive layer, an electrically insulating layer surrounding the first semiconductive layer, and a second semiconductive layer surrounding the electrically insulating layer, the crosslinked layer being the electrically insulating layer.

14. Device according to claim 1, wherein the device is an electric cable accessory, said accessory comprising the crosslinked layer.

15. Device according to claim 14, wherein the accessory is a junction or a termination for an electrical cable.
